(19) United States
(12) Patent Application Publication
(10) Pub. No.: US 2016/0143312 A1
(43) Pub. Date: May 26, 2016

(54) FAT-BASED CONFECTIONERY PRODUCTS

(71) Applicant: NESTEC S.A., Vevey (CH)

(72) Inventors: Shantha Nalur Chandrasekaran, Leeds, Yorkshire (GB); Christopher Brian Pearson, York, Yorkshire (GB)

(21) Appl. No.: 14/904,181

(22) PCT Filed: Jul. 3, 2014
(86) PCT No.: PCT/EP2014/064204

§ 371 Date: Jan. 11, 2016

(30) Foreign Application Priority Data
Jul. 11, 2013 (EP) 13176107.4

(51) Int. Cl. A23G 1/38; A23G 9/32; A23D 9/013; A23G 1/30; A23D 9/007

(52) U.S. Cl. CPC A23G 1/38; A23G 1/305; A23D 9/007; A23D 9/013; A23G 9/322; A23G 9/327; A23V 2002/00

(57) ABSTRACT

The invention relates to the use of encapsulated oils for the preparation of fat based confectionery compositions and products, to confectionery products and compositions comprising encapsulated oil and to processes for the preparation thereof. The encapsulated oil comprises a liquid oil encapsulated in an outer shell comprising cross-linked agent and a structuring agent incorporated into the capsule or added externally.

### FIELD OF THE INVENTION

The present invention relates to fat based confectionery products, more particularly to chocolate and chocolate-like products. Specifically, it relates to the use of an encapsulated liquid oil for the partial replacement of solid fats in the preparation of such fat-based confectionery products, to such confectionery products comprising encapsulated liquid oil and to processes for the preparation thereof.

### BACKGROUND OF THE INVENTION

Any discussion of the prior art throughout the specification should in no way be considered as an admission that such prior art is widely known or forms part of common general knowledge in the field.

Fat-based confectionery products are well known and appreciated by consumers. However, some fat-based confectionery products tend to have a nutritional profile high in total fat and in particular high in saturated fats in order to provide the desired organoleptic properties and textural properties.

The type of fat used in such confectionery products governs the texture as well as other organoleptic properties of the product. In general, confectionery products must provide a sufficiently firm texture to ensure shape stability of the product and to avoid its substantial deformation, and that the product does not become “sticky” sticking to product wrappers, or the hands of a consumer, upon handling the product. The fat used in the products must also be sufficiently solid at the temperature and conditions to which the product is exposed in order to avoid oiling out, i.e. separation of the oil component from the other components of the product. It is also desirable that the product should melt in the mouth and that it should have no or only minor fractions of solids that melt above the blood temperature to yield a creamy, melt-in-mouth mouth feel. In order to impart the required textural and sensorial properties to fat-based confectionery coatings, high SFA, solid type fats are used.

However, high consumption of saturated fatty acids (SFA) is widely considered to have negative health impact.

The hardness and the melting profile of a fat are linked to its degree of saturation. Highly saturated fats are usually solid at ambient conditions, e.g. palm fat, palm kernel fat or any hydrogenated vegetable fat. Low levels of saturation yield a liquid product at ambient conditions, e.g. a sunflower oil.

Hydrogenation of oil is a commonly used technique to obtain solid type fats from liquid oils. Besides the resulting high SFA content, the presence of trans fatty acids in partially hydrogenated fats has become a severe health issue. Saturated fatty acids are known to have negative health impact and are linked to an enhanced risk for cardiovascular diseases. In the recent years, this has led to an increasingly negative consumer perception of saturated fats. Hence it would be desirable to reduce the content of high SFA solid-type fats.

Hence it would be desirable to replace partially or totally high SFA solid-type fats, or hydrogenated fats containing significant levels of trans fatty acids, by low SFA liquid oils. However, for persons skilled in the art it is evident that in most cases of confectionery products it is not possible to use a liquid oil instead of a solid fat. A difficulty in just increasing/replacing the solid fats with low SFA liquid oils is that this impacts on the physical properties such as the taste, texture and the overall appearance of the product (organoleptic parameters). A significant problem for the use of liquid oils in confectionery products is oiling out, i.e. separation of the liquid oil from the other components of the food product, which can result in a visually unacceptable product. Also the replacement of solid fats by low SFA liquid oils in the recipe can have a negative impact on proccessability, such as giving a much softer and stickier ingredient mixture, which can be unprocessable.

The consumer is not willing to compromise on the organoleptic properties of confectionery products in order to reduce consumption of SFA. Taste, texture and overall appearance are such organoleptic properties.

EP0293194A2 describes cocoa butter replacement fats which contains highly unsaturated liquid glyceride oil, particularly high PUFA oil or other cocoa butter softening fat, preferably in encapsulated form. The replacement fat may be added to previously refined chocolate to retain the encapsulation and minimize the effect of the softening fats on the chocolate. The invention provides a cocoa butter fat suitable for replacing at least part of the cocoa butter normally present in chocolate formulations, the fat comprising a combination of a mixture of palm mid-fraction with a hard fat containing at least 50% StOSt/POSt with a softening fat.

WO2012/089691 describes a solid confectionery product comprising pressure agglomerated powder ingredients, wherein said powder ingredients comprise an oil powder for the preparation of a solid confectionery product, and processes for the preparation of a solid confectionery product compacting or shaping the ingredients including an oil powder by a pressure agglomeration process. The compacting or shaping of the powder ingredients is carried out by a pressure agglomeration technique, advantageously by an extrusion process or a powder compaction technique.

US2002/0136818 describes food products that include a liquid fat and a high melting point emulsifier. The liquid fat and a high melting point emulsifier can replace solid fat in the food. There remains a need for fat-based confectionery products, in particular chocolate and chocolate-like products, with improved nutritional profile, particularly reduced SFA content, whilst having good organoleptic properties. It is an object of the invention to overcome or ameliorate at least one of the disadvantages of the prior art, or to provide a useful alternative.

In particular, it is desirable to provide fat-based confectionery products that have a lower SFA content compared to corresponding conventional fat-based confectionery products, without compromising the organoleptic parameters.

It would also be advantageous to provide fat based confectionery products that have a lower SFA content compared to corresponding conventional fat-based confectionery products, and that may be easily industrialized at a reasonable cost.

It would also be advantageous to provide fat-based confectionery product compositions which could be easily processed in view of their rheological properties, in particular for enrobing and molding applications, and which would allow preparation of fat-based confectionery products, in particular chocolate and chocolate-like products, with improved nutritional profile, particularly reduced SFA content, whilst having good organoleptic properties.

### SUMMARY OF THE INVENTION

In one aspect of the present invention, there is provided a fat-based confectionery product comprising an encapsulated oil. The encapsulated oil comprises at least 40% w/w of a liquid oil in an inner core and an encapsulating outer shell comprising a cross-linked agent, wherein such encapsulated oil either further comprises at least one structuring agent or is used in combination with at least one structuring agent in the fat-based confectionary product composition. The fat-based confectionery products of the invention have a firm texture, and good resistance to oiling out. The fat based confectionery products advantageously have a creamy and pleasant mouth feel. The present invention makes it possible to provide fat-based confectionery products with good texture and organoleptic properties, and which are lower in SFA compared to the corresponding conventional products.

Advantageously the confectionery product of the invention have also good temperature tolerance properties.

In another aspect, there is provided the use of an encapsulated oil comprising at least 40% w/w of a liquid oil in an inner core and an encapsulating outer shell comprising a cross-linked agent, to replace partially solid fats for the preparation of a fat base confectionary product, wherein such encapsulated oil either further comprises at least a structuring agent or is used in combination with at least a structuring agent in the fat base confectionary product composition.

In a further aspect, it is provided a fat based confectionery product composition which comprises an encapsulated oil comprising at least 40% w/w of a liquid oil in an inner core and an encapsulating outer shell comprising a cross-linked agent, wherein such encapsulated oil either further comprises at least a structuring agent or is used in combination with at least a structuring agent in the fat base confectionary product composition.

In a still further aspect, there is provided the use of such fat base confectionery product composition for preparing or coating a fat based confectionery product, and fat based confectionery products prepared or coated with the such composition.

In an additional aspect, there is also provided a process for preparing a fat based confectionery product or a fat based confectionery product composition according to the present invention.

In a first embodiment, such process comprises mixing an encapsulated oil comprising at least 40% w/w of a liquid oil in an inner core and an encapsulating outer shell comprising a cross-linked agent and a structuring agent, and optionally a solid fat component, with the remaining ingredients of the fat based confectionery product composition.

In another embodiment, such process comprises mixing an encapsulated oil comprising at least 40% w/w of a liquid oil in an inner core and an encapsulating outer shell comprising a cross-linked agent, and optionally a solid fat component, with a structuring agent and the remaining ingredients of the fat based confectionery product composition.

In an additional aspect, there is also provided a fat based confectionery product composition comprising an encapsulated oil, wherein said encapsulated oil comprises at least 40% w/w of a liquid oil in an inner core and an encapsulating outer shell comprising a cross-linked agent, and wherein either such encapsulated oil further comprises at least one structuring agent or such encapsulated oil is used in combination with at least one structuring agent in the fat-based confectionary product composition, such fat based confectionery product composition being obtainable according to the process of the invention.

These and other aspects, features and advantages of the invention will become more apparent to those skilled in the art from the detailed description of embodiments of the invention, in connection with the attached drawings.

### BRIEF DESCRIPTION OF THE DRAWINGS

FIG. 1 shows the relationship between the SFA content of a lauric fat and its texture. There is a linear relationship between these parameters, more the SFA content harder the fat.

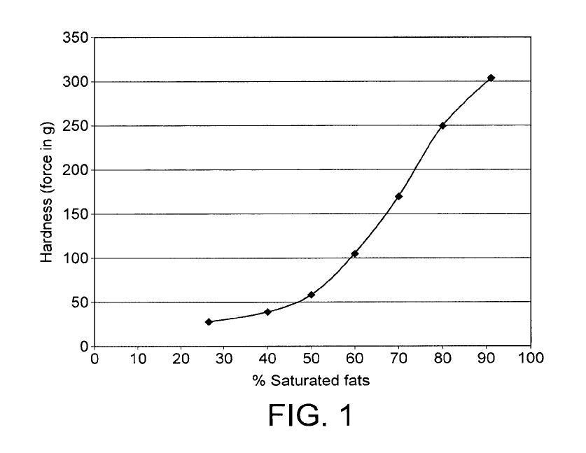

FIG. 2 shows the texture of the different tablet samples made with compositions A, B, C and D prepared as described in Example 1.

FIG. 3 shows the oiling out of the different tablet samples made with compositions A, B, C and D prepared as described in Example 1.

FIG. 4 shows the texture of the different tablet samples made with compositions E, F, G and H prepared as described in Example 4.

FIG. 5 shows the heat resistance when tested at 35 C of the different tablet samples made with compositions E, F, G, H and I prepared as described in Example 4.

### DETAILED DESCRIPTION OF THE INVENTION

According to the present invention, the term “fat based confectionery product” identifies chocolate or chocolate-like based products (also conventionally known as “compound”). Fat based confectionery product of the invention include but are not limited to: a chocolate product, a chocolate-like product (e.g. comprising cocoa butter replacers, cocoa-butter equivalents or cocoa-butter substitutes), a chocolate coated product, a chocolate-like coated product, a chocolate coating for biscuits, wafers or other confectionery items, a chocolate-like coating for biscuits, wafers or other confectionery items, a chocolate coating for ice-creams and the like.

The chocolate or chocolate-like fat-based confectionery product may be in form of a tablet, a bar, an aerated product, or a coating for confectionery products, wafer, biscuits or ice creams, among others. It may also have inclusions, chocolate layers, chocolate nuggets, chocolate pieces, chocolate drops. The fat-based confectionery product may further contain crispy inclusions e.g. cereals, like expanded or toasted rice or dried fruit pieces.

According to the present invention, the term “fat based confectionery product composition” identifies a chocolate or chocolate-like mass (including its recipe and ingredients) which is used for the preparation of fat base confectionery products of the invention. The fat based confectionery product composition may be used to mold a tablet or bar, to coat confectionery items or to prepare more complex chocolate or chocolate-like based products. Optionally, prior to its use in the preparation of a fat based confectionery product of the invention, inclusions according to the desired recipe may be added to the fat based confectionery product composition.

As it will be apparent to a person skilled in the art, in some instances the fat based confectionery product of the invention will have the same recipe and ingredients as the corresponding fat based confectionery product composition while in other instances, particularly where inclusions are added or for more complex confectionery products, the final recipe of the fat based confectionery product may differ from that of the fat based confectionary product composition used to prepare it.

In fat based confectionery chocolate-like products cocoa butter is replaced by fats from other sources. Such products, generally contain lauric fat (cocoa butter substitute, CBS, obtained from the kernel of the fruit of palm trees), or non-lauric vegetable fats (based on palm or other specialty fats), cocoa butter replacer (CBR) or cocoa butter equivalent (CBE). Unfortunately, also CBE, CBR and more so the CBS primarily contain saturated fats and very low levels of the healthy n-3 and n-6 fatty acids.

Accordingly, it would be advantageous to provide chocolate and chocolate-like fat based confectionery products that have a lower SFA content compared to corresponding conventional fat-based confectionery products, and that may be easily industrialized at a reasonable cost. The inventors of the present invention have surprisingly found that fat based confectionery products with good organoleptic properties such as a firm, smooth texture, good resistance to oiling out and desired creamy, melt-in-mouth, mouth feel can be achieved by replacing at least part of the solid fat content of a conventional fat based confectionery product with an encapsulated oil. The encapsulated oil comprises an inner core comprising a liquid oil encapsulated in an outer shell comprising a cross-linked agent, such encapsulated oil further comprising or being used in combination with at least one structuring agent in the fat based confectionery product composition.

As it will be apparent to the person skilled in the art, all embodiments and preferred embodiments herebelow described apply also to the different aspects of the invention mutatis mutandis and may all be combined between each other.

In a preferred embodiment of the present invention, the fat based confectionery product is a chocolate or chocolate-like tablet or bar. In another preferred embodiment, the fat based confectionery product is a chocolate or chocolate-like coating for confectionery items, wafer, biscuits or ice creams.

In a further preferred embodiment, the fat based confectionery product is a chocolate-like tablet or bar or chocolate-like coating for confectionery items, wafer, biscuits or ice creams.

In another preferred embodiment, the chocolate-like confectionery fat-based product composition or product's ingredients don't comprise cocoa butter.

In another preferred embodiment, the chocolate-like fat-based confectionery product composition or product's ingredients comprise lauric fats.

In another preferred embodiment, the confectionery fat-based product composition or product's ingredients don't comprise any liquid oil other than encapsulated liquid oil.

According to a first embodiment of the invention, the encapsulated oil comprises at least 40% w/w of a liquid oil in an inner core and an encapsulating outer shell comprising a cross-linked agent and at least one structuring agent. According to a second embodiment of the invention, the encapsulated oil comprises at least 40% w/w of a liquid oil in an inner core and an encapsulating outer shell comprising a cross-linked agent and such encapsulated oil is used in combination with at least one structuring agent in the fat based confectionary product composition.

The structuring agent is an ingredient having the capacity to structure liquid oil, by its gelation. The structuring agent component imparts a rigidity to the fat that helps to inhibit or prevent changes in the shape of the chocolate composition at elevated temperatures.

Non-limiting examples of structuring agents according to the invention are: waxes (plant, bees and insect waxes), fully hydrogenated vegetable oils (for example and not limited to soybean oil, sunflower oil, palm oil, rapeseed/canola oil, cocoa butter, shea oil, illipe oil, palm kernel oil, and/or combinations thereof) and high temperature melting emulsifiers (having a melting point higher that 40 degrees centigrade).

In a preferred embodiment, the structuring agent is a high temperature melting emulsifier or a fully hydrogenated vegetable oil.

In a more preferred embodiment, the structuring agent is a high temperature melting emulsifier.

In a more preferred embodiment, the structuring agent is a high temperature melting emulsifier having a melting point higher that 40 degrees centigrade.

By way of example, high temperature melting emulsifiers may be selected in the list consisting of: monoglycerides, diglycerides, citric acid esters of monoglycerides and/or diglycerides, lactic acid esters of monoglycerides and/or diglycerides, diacetyl tartaric esters of monoglycerides (DATEM) and/or diglycerides, acetic acid ester of monoglycerides (ACETEM) and/or diglycerides, succinic acid esters of monoglycerides (SMG) and/or diglycerides, lactic acid esters of monoglycerides (Lactem) and/or diglycerides, ethoxylated mono and diglycerides; polyglycerol esters of fatty acids; sorbitan esters and sugar esters, polyglycerol esters of fatty acids and any mixture thereof.

In a preferred embodiment, the structuring agent is selected from the group consisting of: monoglycerides, diglycerides, citric acid esters of monoglycerides and/or diglycerides, lactic acid esters of monoglycerides and/or diglycerides, diacetyl tartaric esters of monoglycerides (DATEM) and/or diglycerides, hexaglyceryl distearate, hexaglyceride monostearate, triglyceryl monostearate and any mixture thereof.

In a further preferred embodiment, the high temperature melting emulsifier is Citric Acid esters of mono and diglycerides.

The liquid oil content of the encapsulated oil is at least 40% w/w, such as from 40 to 99% w/w. Preferably the encapsulated oil comprises at least 60% w/w, such from 60 to 99% w/w, more preferably at least 70% w/w, such from 70 to 99% w/w more preferably at least 80% w/w, such from 80 to 99% w/w. In some embodiments the liquid content of the encapsulated oil can be at least 90% w/w oil, such as at least 95% w/w, or even at least 99% w/w oil. For instance, in one preferred embodiment the encapsulated oil contains from 70% to 99% w/w oil, encapsulated in an outer shell of cross-linked protein. In one embodiment the encapsulated oil comprises from 85% to 98% w/w, preferably from 90% to 98% w/w oil, such as from 90% to 97% w/w oil. Above 99% w/w oil content the encapsulated oil can start to lose its solid state properties.

The encapsulated oil can be obtained by known emulsion-based encapsulation processes. These processes have in common that they are based on an oil-in-water emulsion that is dried to obtain an encapsulated oil. The drying step can be carried out by any commonly known drying technique such as air drying, ventilation, spray drying, vacuum drying, freeze drying, etc. Prior to the drying step, a step of cross-linking an appropriate agent may be applied. Suitably this may be effected by a heat treatment, a chemical treatment or an enzymatic treatment to crosslink the selected agent, e.g. milk proteins. Preferably, the final encapsulated oil usually consists of a liquid vegetable oil that is encapsulated in a matrix material consisting of proteins, carbohydrates (such as sugars, for instance lactose, glucose, maltodextrin, a starch, cellulose), or surface active agents, or mixtures thereof.

The oil used for preparing the emulsion can be any vegetable, animal or fish oil which is liquid under ambient temperature and pressure conditions. The oil is suitably a food grade oil. Examples of such oils include: sunflower oil, rapeseed oil, olive oil, soy oil, fish oil, canola oil, linseed oil, safflower oil, corn oil, algae oil, cottonseed oil, palm oil, palm kernel oil, coconut oil, grape seed oil, a nut oil such as hazelnut oil, walnut oil, or other nut oil, peanut oil, rice bran oil, sesame oil, cocoa butter, milk fat or combinations thereof. Optionally, the oil can contain one or more liposoluble compounds; such as for example plant polyphenols, fatty acids, such as n-3 fatty acids, n-6 fatty acids, vitamins, aromas, flavors, antioxidants, other active ingredients. Exemplary antioxidants for optimizing oxidative stability of the oil include ascorbic acid, ascorbyl palmitate, citric acid, rosmarinic extract, BHA, BHT, mixed tocopherols, citric acid and EDTA. Preferably, a vegetable oil is used, more preferably an oil with a low SFA content is chosen such as high oleic sunflower oil or high oleic rapeseed oil.

The cross-linked agent may be a protein, carbohydrate, surface active agent, or mixtures thereof. Preferably the cross-linked agent is a protein, and can be any food-grade protein such as milk and/or whey proteins, soy proteins, pea proteins, caseinate, egg albumen, lyzozyme, gluten, rice protein, corn protein, potato protein, lupin protein, pea protein, skimmed milk proteins or any kind of globular and random coil proteins as well as combinations thereof. The proteins may optionally comprise food grade salts, such as sodium citrate, magnesium citrate, potassium citrate, calcium phosphate or combinations thereof. Such salts may be present in an amount typically up to 10%w/w, preferably from 0 to 5% w/w. In one preferred embodiment the protein is one or more milk and/or whey derived protein.

Preferred milk proteins or milk protein fractions in accordance with the present invention comprise, for example, whey proteins, α-lactalbumin, β-lactoglobulin, bovine serum albumin, acid casein, caseinates, α-casein, β-casein.

As far as whey proteins are concerned, the protein source may be based on acid whey or sweet whey or mixtures thereof and may include α-lactalbumin and β-lactalbumin in any proportions. The proteins may be intact or at least partially hydrolysed.

Typically the encapsulated oil comprises at least 0.5% w/w and up to about 30% w/w, preferably up to about 20% w/w, more preferably up to about 15% w/w of the cross linked agent, preferably a protein. In one preferred embodiment the encapsulated oil comprises from about 0.5% w/w to about 10% w/w cross linked agent, such as from about 0.5% w/w to about 5% w/w cross linked agent, preferably a protein. In one preferred embodiment an encapsulated oil according to the invention comprises a maximum of 15% w/w of the protein based agent. In another preferred embodiment an encapsulated oil according to the invention comprises a maximum of 10% w/w of the protein based agent. In a further embodiment an encapsulated oil according to the invention comprises a maximum of 5% w/w of a protein. In some embodiments embodiment the encapsulated oil comprises a maximum of 1% w/w of a protein. In another preferred embodiment an encapsulated oil according to the invention comprises from about 1% w/w to about 20% w/w of the protein, more preferably from about 2% w/w to about 15% w/w of the protein, such as from about 3% w/w to about 15% w/w of the protein. In another preferred embodiment an encapsulated oil according to the invention comprises from about 3% w/w to about 10% w/w of the protein.

The single particles of encapsulated oil according to the invention typically have an average particle diameter in the range of form about 0.1 to 200 μm, for example about 1 to 100 μm, or 1 to 50 μm.

At the beginning of the refining process, the single particles of encapsulated oil according to the invention have an average particle diameter in the range of from 30 to 300 μm, preferably from 30 to 250 μm, more preferably 50 to 200 μm.

According to the present invention, the encapsulated oil further comprises or is used in combination with at least one structuring agent, wherein the amount of such structuring agent ranges from at least 0.05% w/w to up to 25% w/w of the fat based confectionery product composition. In a preferred embodiment, the amount of such structuring agent ranges from at least 0.05% w/w to up to 10% w/w, more preferably from 0.1 to 5% w/w of the fat based confectionery product composition.

According to a first embodiment of the invention, the encapsulated oil comprises at least 0.1 w/w and up to about 25% w/w, preferably up to about 15% w/w, more preferably up to about 10% w/w of the structuring agent in the encapsulated oil. According to a first embodiment of the invention, the encapsulated oil comprises at least 0.05 w/w and up to about 10% w/w, preferably up to about 5% w/w, more preferably up to about 2% w/w of the structuring agent in the fat based confectionery product composition.

According to a second embodiment of the invention, the encapsulated oil is used in the fat based confectionery product composition in combination with at least one structuring agent wherein such structuring agent is present at least 0.1% w/w and up to about 15% w/w of the fat based confectionery product composition, preferably up to about 10% w/w, more preferably up to about 5% w/w.

According to preferred embodiment of the invention, there is provided a fat based confectionery product composition comprising an encapsulated oil, wherein said encapsulated oil comprises at least 40% w/w of a liquid oil in an inner core and an encapsulating outer shell comprising a cross-linked agent, and wherein either such encapsulated oil further comprises at least one structuring agent or such encapsulated oil is used in combination with at least one structuring agent in the fat-based confectionary product composition; wherein the structuring agent is an high melting point emulsifier and is selected from the group consisting of: monoglycerides, diglycerides, citric acid esters of monoglycerides and/or diglycerides, lactic acid esters of monoglycerides and/or diglycerides, diacetyl tartaric esters of monoglycerides (DATEM) and/or diglycerides, acetic acid ester of monoglycerides (ACETEM) and/or diglycerides, succinic acid esters of monoglycerides (SMG) and/or diglycerides, lactic acid esters of monoglycerides (Lactem) and/or diglycerides, ethoxylated mono and diglycerides; polyglycerol esters of fatty acids; sorbitan esters and sugar esters, polyglycerol esters of fatty acids and any mixture thereof; wherein the amount of the at least one structuring agent ranges from at least 0.05% w/w to up to 25% w/w of the fat based confectionery product composition; wherein the cross linking agent is a protein and comprises at least one food-grade protein, such as whey protein, caseinate, egg albumen, lyzozyme, soy proteins, gluten, rice proteins, corn proteins, potato proteins, pea proteins, or any kind of globular and random coil proteins or combinations thereof; and which comprises from 5% to 70% w/w, preferably from 5 to 40% w/w of the encapsulated oil.

Emulsion based processes to obtain encapsulated oils are known and suitable encapsulated oils are commercially available. Suitable such encapsulated oils can be prepared according to known processes, for instance, such as described in EP 1 998 627, WO2010/057852, WO2008/066380.

According to one embodiment the encapsulated oil may be prepared by an emulsion based process, comprising preparing an emulsion of the oil, the cross linked agent (preferably a protein), and optionally a food grade salt and/or a liposoluble compound; crosslinking the protein, for example by heating, UV-radiation, chemically or enzymatically; spray-drying the emulsion to generate the encapsulated oil. According to one embodiment an encapsulated oil as described in WO2010/057852 is used.

The fat based confectionery product and composition according to the invention may typically comprise about 1% to 70% w/w, preferably from about 1 to 60% w/w, preferably from about 1 to 50% w/w, 1% to 40% w/w, preferably from about 5 to 30% w/w, more preferably from about 5 to 25%, such as from about 5 to 20% w/w, of the encapsulated oil. Fat based solid confectionery products typically comprise from about 5 to 70% (w/w) solid fats, typically from about 10 to 55% (w/w), such as from about 20-50% (w/w) solid fats.

Typical solid fats include coconut oil, palm kernel oil, palm oil, cocoa butter, butter oil, lard, tallow, oil/fat fractions such as lauric or stearic fractions, hydrogenated oils, and blends thereof.

In the preparation of the fat based confectionery products of the present invention encapsulated oils are to replace partially the usual solid fats used in the preparation of solid fat-based confectionery products. Typical solid fat replacement ratios are from about 1% to 70%, preferably from about 5% to 60%, preferably from about 10% to 50%. Preferred replacement ratios depend amongst others on the desired texture and other organoleptic properties of the confectionery products. Higher replacement ratios can in some cases lead to products with a more sticky/softer texture. At very high, above 70%, replacement ratios there can be a degree of leakage of the oil from the encapsulated oil less desirable for certain applications.

One beneficial feature of the present invention is the flexibility of the approach in terms of ingredients. The present invention is not related to particular fat fractions or crystallizing agents. In the present invention any type of oil with a desired degree of saturation can be used. In doing so, a reduction in SFA content of up to about 70% compared to a fat based confectionery product based on conventional solid fats can be obtained.

Preferably the other powder ingredients of the confectionery product according to the invention include a sugar and/or cocoa powder.

Any sugar or sugar substitute may be contemplated. Typical suitable sugars include sucrose, dextrose, fructose and lactose, preferably sucrose.

In some embodiments the fat based confectionery product or composition of the invention comprises an amount of sugar of about 5 to 70% w/w, preferably from about 5 to 60% w/w, such as from about 5 to 55% w/w, such as from about 10 to 50% w/w sugar.

In some embodiments the fat based confectionery product or composition of the invention contains cocoa powder in an amount from 1 to 80% w/w, preferably from about 5 to 70% w/w, such as from about 5 to 50% w/w, from about 5 to 40% w/w, from about 5 to 30% w/w, for instance around 5 to 20% w/w cocoa powder.

The confectionery product according to the invention may comprise other common ingredients of a fat-based confectionery, such as, for example, solid fats, chocolate, whey powder, fruit acids, natural or synthetic flavors, natural or artificial colors, starch based fillers, fibres, nut powders, inclusions such as small pieces of nuts, dried fruits, sugar confectionery for example, emulsifiers such as lecithin, flow aids such as starches.

In one preferred embodiment, the fat based confectionery product composition of the invention comprises an agent to adjust its rheological properties. In one preferred embodiment, such agent is lecithin or PGPR. When present, such agents are used at a concentration between 0 and 3%, preferably less than 1%.

In some embodiments the fat based confectionery product or composition of the invention comprises from 1 to 40% w/w milk powder, more preferably from 5% to 30% w/w milk powder.

In some embodiments the fat based confectionery product or composition of the invention comprises from 5 to 40% w/w of a solid fat, from 5 to 40% w/w of encapsulated oil, and from 5% to 40% w/w of milk powder.

According to some embodiments a fat based confectionery product or composition according to the invention may comprise from 20-65% total fat, wherein 1-70% of fat can come from encapsulated oil, and from about 0-40% w/w of milk powder.

According to a preferred embodiment of the present invention, a process for the preparation of a fat based confectionery product composition or product is provided wherein the encapsulated oil is mixed with other ingredients before refining the fat based confectionery product composition.

Without wishing to be bound by theory, it is believed that refining the mixture of ingredients already comprising the encapsulated oil helps in providing thethe fat based confectionery product composition's desired rheology/flow properties.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

It should be noted that embodiments and features described in the context of one of the aspects or embodiments of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

### Preparation of Tablets Made with a Range of White Chocolate-Like Compositions

Four different fat based Chocolate-like confectionery compositions were prepared according to the ingredients in Table 1 and used according to process here below reported to prepare corresponding tablet samples to be tested:

TABLE 1

| | Compo- | Compo- | Compo- | Compo- |
|---|---|---|---|---|
| | sition A | sition B | sition C | sition D |
| Ingredients | w/W % | w/W % | w/W % | w/W % |
| Sugar | 42.83 | 42.83 | 42.83 | 42.83 |
| Skimmed Milk | 25.12 | 25.12 | 24.00 | 20.80 |
| Powder Dry Mix | | | | |
| Lecithin | 0.15 | 0.15 | 0.35* | 0.35* |
| vanillin | 0.08 | 0.08 | 0.08 | 0.08 |
| Lauric fat | 31.80 | 21.72 | 21.72 | 21.72 |
| Sunflower oil | 0.00 | 10.80 | 0.00 | 0.00 |
| Encapsulated oil α | 0.00 | 0.00 | 11.20 | 0.00 |
| Encapsulated oil | 0.00 | 0.00 | 0.00 | 14.40 |
| comprising β | | | | |
| PGPR (Polyglycerol | 0.00 | 0.00 | 0.30* | 0.30* |
| polyricinoeate) | | | | |
| % SFA in fat | 95 | 65 | 65 | 65 |
| Total | 99.99 | 99.98 | 99.98 | 99.98 |

*Needed to add extra 0.2% lecithin and 0.3% PGPR to adjust for viscosity of products using encapsulated oils.

Process of preparation of confectionery tablets made with composition A, B, C or D:

Processing—Making of chocolate-like composition: A standard method of mixing (40 C, 10 min), refining (particle size 25-30 microns), conching (55 C, 1 h) and standardization was followed. All masses were processable, masses with encapsulated oils were thicker in flow property, their rheology was adjusted by adding more of lecithin (0.2%) and PGPR (0.3%).

Molding—All molding operations were done in a standard cooling tunnel. Coating was deposited into molds and passed through the cooling tunnel maintained at 6-8 C, with a residence time of 25 minutes. Tablets were demolded and stored at room temperature (17-20 C).

Differences for tested tablet samples A,B,C and D molded from compositions A,B,C and D respectively are as follows:
Tablet A: standard chocolate like tablet of reference;
Tablet B: chocolate-like tablet of reference where part of the lauric fat was replaced by Sunflower oil;
Tablet C: chocolate-like tablet of reference where part of the lauric fat and skim milk powder was replaced with Encapsulated oil α (containing 90% sunflower oil and 10% of milk protein, not containing any Structuring agent);
Tablet D: chocolate-like tablet of reference where part of the lauric fat and skim milk powder was replaced with encapsulated oil β [comprising a structuring agent and commercially available from Cognis: sunflower oil ˜70%, Glucose Syrup solids ˜16%, Milk protein ˜14% High Melting point Emulsifier (E 472c: Citric Acid ester of mono and diglycerides) ˜6%, antioxidant ˜0.1%];

### Example 2

### Evaluation of Product Texture for White Chocolate-Like Tablets A, B, C and D

Molded tablets were left for a week at room temperature before analysis. Samples were analyzed for their hardness using a Texture Analyzer, TAXT2 (Stable Micro Systems Ltd., UK) equipped with Exponent 32 software for data interpretation. A P/N* steel needle probe was used to determine the maximum force required to penetrate the compound tablets. The probe was programmed to travel for 2.9 mm of depth through sample with a force threshold of 5.1 g. Test speed was set at 1 mm/sec and return to start position at the same speed. Ten samples were tested for each tablet type.

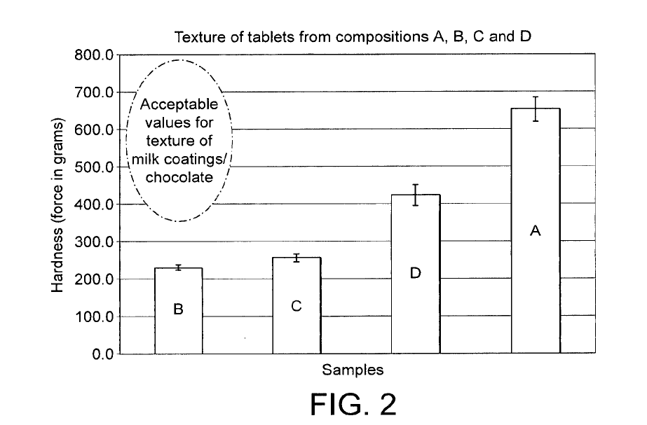

As can be seen from FIG. 2, the tablets from composition A are very hard in texture (˜650 g) and all other samples containing liquid oil have lower hardness than this. Tablets made with composition B was softer than those made with composition C, which in turn is softer than the tablets made using composition D. Although the tablets made with composition D was slightly lower in hardness compared to the tablets made with composition A, their hardness is still in the acceptable range of textures for chocolates, tablets or coatings.

### Example 3

### Evaluation of Oiling Out at Elevated Temperature for White Chocolate Like Tablets A, B, C and D

The tablets were put on filter paper and subject to different temperatures in a controlled temperature oven for 60 min. The temperatures studied were 32, 34, 36 and 38° C. The products were then observed for oiling out and photographed.

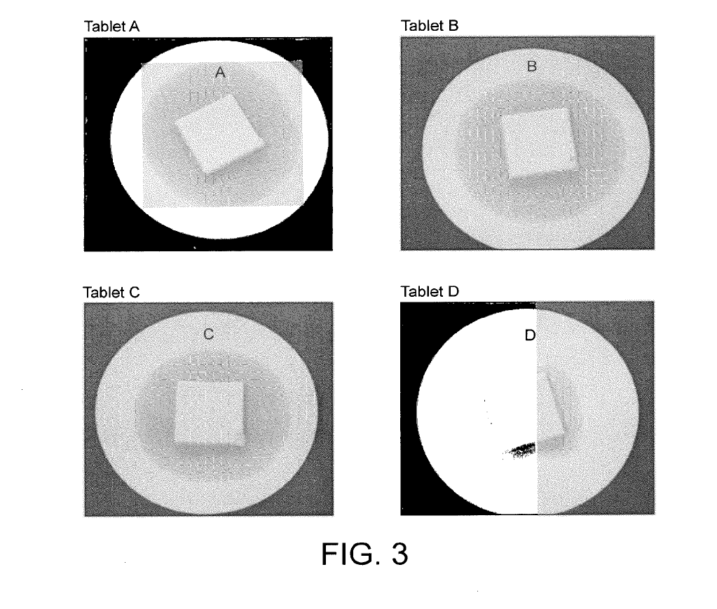

The chocolate-like fat melts at 35 C and hence tablet A shows oiling at 38 C (FIG. 3). The tablet B is similar to the control with respect to oiling out. The tablet C was slightly less than tablet B. The tablet D oiled out the least.

### Example 4

### Preparation of Tablets Made with a Range of Brown Chocolate-Like Compositions

Five different fat based Chocolate-like confectionery compositions were prepared according to the ingredients in Table 2 and used according to process here below reported to prepare corresponding tablet samples to be tested:

TABLE 2

| | Compo- | Compo- | Compo- | Compo- | Compo- |
|---|---|---|---|---|---|
| | sition E | sition F | sition G | sition H | sition I |
| Ingredients | w/W % | w/W % | w/W % | w/W % | w/W % |
| Sugar | 51.17 | 51.17 | 51.17 | 51.17 | 51.17 |
| Skimmed Milk | 8.77 | 5.62 | 5.62 | 4.92 | 5.62 |
| Powder Dry Mix | | | | | |
| Soya Lecithin Liquid | 0.41 | 0.30 | 0.30 | 0.30 | 0.30 |
| Vanilla Flavor | 0.01 | 0.01 | 0.01 | 0.01 | 0.01 |
| Lauric fat | 28.95 | 21.00 | 19.00 | 20.95 | 19.00 |
| Dry Sweet Whey powder | 3.66 | 3.66 | 3.66 | 3.66 | 3.66 |
| Cocoa powder | 7.02 | 7.02 | 7.02 | 7.02 | 7.02 |
| Encapsulated oil χ | 0.00 | 11.10 | 11.10 | 0..00 | 11.10 |
| Structuring agent | 0.00 | 0.00 | 2.00 | 0.00 | 0.00 |
| (fully hydrogenated oil) | | | | | |
| Structuring agent | 0.00 | 0.00 | 0.00 | 0.00 | 2.00 |
| [monoglycerides | | | | | |
| (melting point ~64 C.] | | | | | |
| Encapsulated oil β | 0.00 | 0.00 | 0.00 | 11.85 | 0.00 |
| PGPR (Polyglycerol | 0.0 | 0.20 | 0.20* | 0.20* | 0.20* |
| polyricinoeate) | | | | | |
| SFA | ~90 | ~65 | ~65 | ~65 | ~65 |
| Total | 99.99 | 99.98 | 99.98 | 99.98 | 99.98 |

*Needed to add extra 0.2% PGPR to adjust for viscosity of products using encapsulated oils.

Process of preparation of confectionery tablets made with composition E,F,G,H,I:

Processing—Making of mass: A standard method of mixing (40 C, 10 min), refining (particle size 35-41 microns), conching (55 C, 1 h) and standardization was followed. All masses were processable, masses with encapsulated oils were thicker in flow property, their rheology was adjusted by adding PGPR (0.3%).

Molding—All molding operations were done in a standard cooling tunnel. Coating was deposited into molds and passed through the cooling tunnel maintained at 6-8 C, with a residence time of 25 minutes. Samples were demolded, wrapped in foil and stored at room temperature (17-20 C).

Differences for tested tablet samples E,F,G,H and I molded from compositions E, F, G, H and I respectively are as follows:
Tablet E: standard chocolate-like tablet of reference;
Tablet F: chocolate-like tablet of reference where part of the lauric fat and skim milk powder was replaced by encapsulated oil χ [Encapsulated oil not containing a structuring agent, commercially available from Kievit: sunflower oil 78%, Glucose Syrup oil 15%, Milk protein, caseinate 6.5% antioxidant ˜0.1%];
Tablet G: chocolate-like tablet of reference where part of the lauric fat and a corresponding amount of skim milk powder was replaced by encapsulated oil χ [Encapsulated oil not containing a structuring agent, commercially available from Kievit: sunflower oil 78%, Glucose Syrup oil 15%, Milk protein, caseinate 6.5% antioxidant ˜0.1%] used with in combination with a structuring agent (fully hydrogenated palm and rapeseed fat);
Tablet H: chocolate-like tablet of reference where part of the lauric fat and a corresponding amount of skim milk powder was replaced with encapsulated oil β [comprising a structuring agent and commercially available from Cognis: sunflower oil ˜70%, Glucose Syrup solids ˜16%, Milk protein ˜14% High Melting point Emulsifier (E 472c: Citric Acid ester of mono and diglycerides) ˜6%, antioxidant ˜0.1%];
Tablet I: chocolate-like tablet of reference where part of the lauric fat and a corresponding amount of skim milk powder was replaced by encapsulated oil χ [Encapsulated oil not containing a structuring agent, commercially available from Kievit: sunflower oil 78%, Glucose Syrup oil 15%, Milk protein, casinate 6.5% antioxidant ˜0.1%] used with in combination with a structuring agent (monoglycerides, MP, ˜64 C).

### Example 5

### Evaluation of Product Texture for Tablets E, F, G and H

Molded tablets were left for a week at room temperature before analysis. Samples were analyzed for their hardness using a Texture Analyzer, TAXT2 (Stable Micro Systems Ltd., UK) equipped with Exponent 32 software for data interpretation. A P/N* steel needle probe was used to determine the maximum force required to penetrate the compound tablets. The probe was programmed to travel for 2.9 mm of depth through sample with a force threshold of 5.1 g. Test speed was set at 1 mm/sec and return to start position at the same speed. Ten samples were tested for each tablet type.

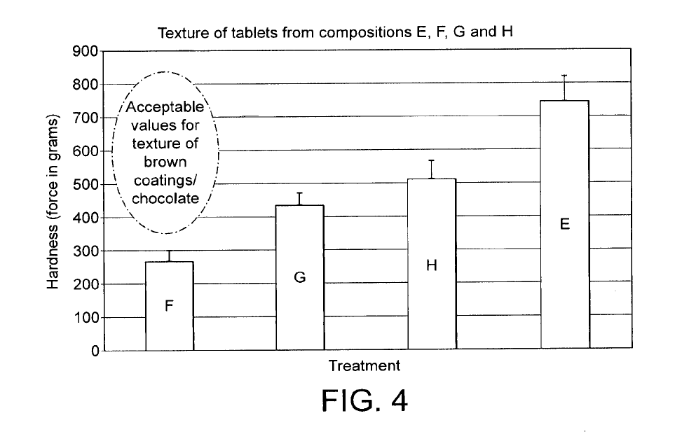

As can be seen from FIG. 4, samples made with coating composition E are very hard in texture (˜725 g) and all other samples containing liquid oil have lower hardness than these. Samples made with coating composition F were soft. However, when structuring agent was added to it (samples made with coating composition G) the texture was harder and acceptable. Similarly samples made with the coating composition H were also harder than those made with the encapsulated SFO oil from Kievit. Although the samples made with the coating compositions G and H were lower in hardness compared to the samples made with coating composition E, they are still in the acceptable range of textures for chocolate bars, tablets or coatings.

### Example 6

### Evaluation of Heat Resistance/Oiling out for Tablets E, F, G, H and I

The wrapped tablets were placed in a tray and subject to different temperatures in a controlled temperature oven for 60 min. The temperatures studied were 32, 34 and 35° C. The products were then observed for their stickiness to the wrapper and photographed.

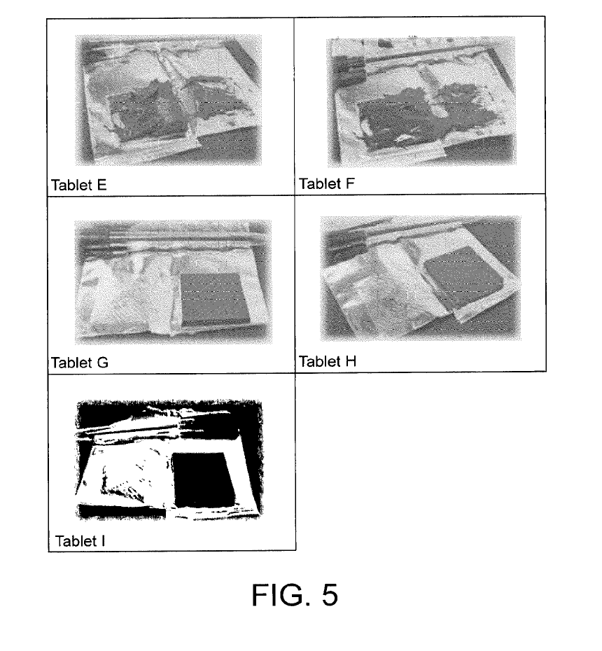

As can be observed from FIG. 5, the sample made with coating composition E melts at 35 C. The sample made with coating composition F is similar the sample made with coating composition E and they both stick to the wrapping paper. Samples made with coating compositions G, H and I, which contain structuring agents in addition to the encapsulated oil maintained their shape and did not melt.

### Example 7

### Evaluation of Shelf-Life for Tablets E, F, G, H and I

The wrapped tablets were put on storage studies in stoves maintained under three different sets of conditions and were drawn every month and analyzed for heat-resistance and by sensory evaluation for appearance, texture and flavor (sensory evaluation performed by an informal sensory panel who rated the tablets for appearance, texture, waxiness/slow melting, flavor release). The testing conditions included ambient storage (18-20 deg C.), and at accelerated conditions, 25° C./75 RH (relative humidity) and, 30° C./85 RH. The main objective of this shelf life studies was to highlight the possible changes in attributes during the aging of the samples according to the invention as compared to the reference sample. Samples in accelerated conditions were tested for 4 months and those in ambient were tested for a year.

All tested samples held well over the accelerated and ambient shelf life evaluation, no visual bloom was observed. Among the samples the reference samples E was picked up as being slightly drier than the treatments over time, the sample with encapsulated sunflower oil (sample F) was perceived as being oily, while sample G, H and I, which have the encapsulated oil with structuring agents had no special perceivable attributes. All products (E to I) were found to be acceptable over the shelf-life.

### Example 8

### Enrobing Biscuits with Chocolate-Like Mass Compositions G and H

The compositions G and H as per Example 4 above, were used to enrobe biscuits using a Sollich enrober. The air flow was adjusted to give a ratio of the coating to biscuit 55% coating, 45% biscuit. The enrobed biscuit was then passed through the cooling tunnel. The temperature of the cooling tunnel was maintained at 6 C and the residence time was 7 min. The enrobed biscuits were then packed in metallic film and stored for further studies.

It will be apparent to a person skilled in the art that fat based confectionery compositions described above in Example 1 and 4 (in particular D, G, H and I) may be easily used for the preparation of fat based chocolate and chocolate-like confectionery products, with corresponding results in terms of texture and heat resistance for the coating of such confectionery products.

1. A fat based confectionery product composition comprising an encapsulated oil, wherein the encapsulated oil comprises at least 40% w/w of a liquid oil in an inner core and an encapsulating outer shell comprising a cross-linked agent, and wherein either such encapsulated oil further comprises at least one structuring agent or such encapsulated oil is used in combination with at least one structuring agent in the fat-based confectionary product composition.

2. A fat based confectionery product composition according to claim 1 wherein the structuring agent is a high melting point emulsifier and is selected from the group consisting of: monoglycerides, diglycerides, citric acid esters of monoglycerides and/or diglycerides, lactic acid esters of monoglycerides and/or diglycerides, diacetyl tartaric esters of monoglycerides (DATEM) and/or diglycerides, acetic acid ester of monoglycerides (ACETEM) and/or diglycerides, succinic acid esters of monoglycerides (SMG) and/or diglycerides, lactic acid esters of monoglycerides (Lactem) and/or diglycerides, ethoxylated mono and diglycerides; polyglycerol esters of fatty acids; sorbitan esters and sugar esters, polyglycerol esters of fatty acids and any mixture thereof.

3. A fat based confectionery product composition according to claim 1, wherein the amount of the at least one structuring agent ranges from at least 0.05% w/w to up to 25% w/w of the fat based confectionery product composition.

4. A fat based confectionery product composition according to claim 1 wherein the cross linked agent is a protein and comprises at least one food-grade protein.

5. A fat based confectionery product composition according to claim 1 which comprises from 5% to 70% w/w of the encapsulated oil.

6. A fat based confectionery product composition according to claim 1 comprising an encapsulated oil, wherein the encapsulated oil comprises at least 40% w/w of a liquid oil in an inner core and an encapsulating outer shell comprising a cross-linked agent, and wherein such encapsulated oil further comprises at least one structuring agent.

7. A fat based confectionery product composition according to claim 1 comprising an encapsulated oil, wherein the encapsulated oil comprises at least 40% w/w of a liquid oil in an inner core and an encapsulating outer shell comprising a cross-linked agent, and wherein such encapsulated oil is used in combination with at least one structuring agent in the fat-based confectionary product composition.

8. A fat based confectionery product which comprises a fat base confectionery product composition comprising an encapsulated oil, wherein the encapsulated oil comprises at least 40% w/w of a liquid oil in an inner core and an encapsulating outer shell comprising a cross-linked agent, and wherein either such encapsulated oil further comprises at least one structuring agent or such encapsulated oil is used in combination with at least one structuring agent in the fat-based confectionary product composition.

9. A fat based confectionery product according to claim 8 which is selected from the group consisting of a chocolate, chocolate-like tablet, bar, and a coating for confectionery products.

10. A method of producing a product by using an encapsulated oil comprising at least 40% w/w of a liquid oil in an inner core and an encapsulating outer shell comprising a cross-linked agent, to prepare a fat base confectionary product composition, wherein such encapsulated oil comprises at least a structuring agent.

11. A method of producing a product by using an encapsulated oil comprising at least 40% w/w of a liquid oil in an inner core and an encapsulating outer shell comprising a cross-linked agent for the preparation of a fat base confectionary product, wherein such encapsulated oil is used in combination with at least a structuring agent in the fat base confectionary product composition.

12. A process for the preparation of a fat based confectionery product composition comprising the steps of:
providing an encapsulated oil, wherein said encapsulated oil comprises an inner core comprising an oil and an encapsulating outer shell comprising cross-linking agent and at least structuring agent, and wherein the encapsulated oil comprises at least 40% w/w oil; and
mixing the encapsulated oil with other ingredients of the fat based confectionery product composition.

13. A process for the preparation of a fat based confectionery product composition comprising the steps of:
providing an encapsulated oil, wherein said encapsulated oil comprises an inner core comprising an oil and an encapsulating outer shell comprising cross-linking agent, and wherein the encapsulated oil comprises at least 40% w/w oil; and
mixing the encapsulated oil with the at least one structuring agent and other ingredients of the fat based confectionery product composition.

14. A process for the preparation of a fat based confectionery product comprising the steps of:
providing an encapsulated oil, wherein said encapsulated oil comprises an inner core comprising an oil and an encapsulating outer shell comprising cross-linking agent and at least structuring agent, and wherein the encapsulated oil comprises at least 40% w/w oil; and
mixing the encapsulated oil with other ingredients of the fat based confectionery product composition.

15. A process for the preparation of a fat based confectionery product comprising the steps of:
providing an encapsulated oil, wherein said encapsulated oil comprises an inner core comprising an oil and an encapsulating outer shell comprising cross-linking agent, and wherein the encapsulated oil comprises at least 40% w/w oil; and
mixing the encapsulated oil with the at least one structuring agent and other ingredients of the fat based confectionery product composition.

16. A process according to claim 12 wherein the encapsulated oil is mixed with other ingredients before refining the fat based confectionery product composition.

17-18. (canceled)

19. A process according to claim 13 wherein the encapsulated oil is mixed with other ingredients before refining the fat based confectionery product composition.

20. A process according to claim 14 wherein the encapsulated oil is mixed with other ingredients before refining the fat based confectionery product composition.

21. A process according to claim 15 wherein the encapsulated oil is mixed with other ingredients before refining the fat based confectionery product composition.
